(19) United States
(12) Patent Application Publication
(10) Pub. No.: US 2014/0358304 A1
(43) Pub. Date: Dec. 4, 2014

(54) Method and Apparatus for Managing Fluid Supply in a Process Control System

(71) Applicant: TESCOM CORPORATION, Elk River, MN (US)

(72) Inventor: Gordon Cameron Muir, Maple Grove, MN (US)

(73) Assignee: TESCOM CORPORATION, Elk River, MN (US)

(21) Appl. No.: 14/278,067

(22) Filed: May 15, 2014

Related U.S. Application Data
(60) Provisional application No. 61/830,574, filed on Jun. 3, 2013.

(51) Int. Cl. G05D 7/06

(52) U.S. Cl. CPC G05D 7/0617
USPC 700/283

(57) ABSTRACT

A method of managing fluid supply in a process control system is provided. The method includes identifying, via a controller of a pilot device, a predetermined minimum source pressure, the predetermined minimum source pressure being the minimum pressure required at a fluid supply source to permit a simultaneous operation of all of a plurality of process lines. The method also includes determining, via the controller, whether a pressure of the fluid supply source is less than the predetermined minimum source pressure. The method further includes determining, via the controller, that the fluid supply source is to be changed when the pressure of the fluid supply source is less than the predetermined minimum source pressure.

### CROSS-REFERENCE TO RELATED APPLICATIONS

The priority benefit of U.S. Provisional Patent Application No. 61/830,574, filed Jun. 3, 2013, is hereby claimed and the entire contents thereof are incorporated herein by reference.

### FIELD OF THE DISCLOSURE

The present disclosure is directed to process control systems and, more particularly, field devices such as pressure regulators and pilot loading mechanisms for pressure regulators used in process control systems.

### BACKGROUND

Process control systems, such as distributed or scalable process control systems like those used in chemical, petroleum or other processes, typically include one or more process controllers communicatively coupled to one or more field devices via analog, digital or combined analog/digital buses. The field devices, which may include, for example, control valves, valve positioners, switches and transmitters (e.g., temperature, pressure and flow rate sensors), perform functions within the process such as opening or closing valves and measuring process parameters. The process controller receives signals indicative of process measurements made by the field devices and/or other information pertaining to the field devices, and uses this information to execute or implement one or more control routines to generate control signals, which are sent over the buses to the field devices to control the operation of the process. Information from each of the field devices and the controller is typically made available to one or more applications executed by one or more other hardware devices, such as host or user workstations, personal computers or computing devices, to enable an operator to perform any desired function regarding the process, such as setting parameters for the process, viewing the current state of the process, modifying the operation of the process, etc.

A compressed gas source typically supplies pressurized gas to a process control system. As the process control system draws pressurized gas from the compressed gas source, the supply pressure decreases. To ensure that any processes in a process control system are not starved, and to prevent any supply interruptions, the operator of the process control system calculates a predetermined weight of the gas source that is judged to be necessary to fulfill the needs of the process control system. Using scales, the operator monitors the weight of the gas source. When the weight of the gas source approaches or falls below this predetermined weight, the operator changes the gas source.

The predetermined weight is, however, calculated based on the assumption that all processes are simultaneously in use, such that all of the processes are able to run at the same time. In reality, however, this is hardly ever the case. In many cases, only a fraction of these processes operates at the same time. Accordingly, operators of process control systems often change gas sources before they actually need to. This can be both expensive and time-consuming.

### SUMMARY

One aspect of the present disclosure includes a method of managing fluid supply in a process control system having a fluid supply source, a regulator, a pilot device, a feedback sensor, and a plurality of process lines. The method includes identifying, via a controller of the pilot device, a predetermined minimum source pressure, the predetermined minimum source pressure being the minimum pressure required at the fluid supply source to permit a simultaneous operation of all of the process lines. The method also includes determining, via the controller, whether a pressure of the fluid supply source is less than the predetermined minimum source pressure. The method further includes determining, via the controller, that the fluid supply source is to be changed when the pressure of the fluid supply source is less than the predetermined minimum source pressure.

### BRIEF DESCRIPTION OF THE DRAWINGS

FIG. 1 is a schematic representation of a process control system having one or more pilot devices constructed in accordance with the principles of the present disclosure.

FIG. 2 is a cross-sectional side view one version of an intelligent regulator assembly, one version of a fluid supply system, and process lines constructed in accordance with the principles of the present disclosure.

FIG. 3 is a block diagram of one version of a pilot device of the intelligent regulator assembly shown in FIG. 2.

FIG. 4 is a block diagram of one version of a personal computing device of the intelligent regulator assembly shown in FIG. 2.

FIG. 5 is a process flow chart showing one version of a method for managing fluid supply in a process control system in accordance with the present disclosure.

FIG. 6 is an exemplary graphical representation of required dome pressure as a function of flow requirements of process lines.

### DETAILED DESCRIPTION

The present disclosure is directed to a process control system having a fluid supply system coupled to an intelligent regulator assembly, which is, in turn, coupled to a plurality of process lines. The intelligent regulator assembly has a pilot device, which can be a field device of a process control system, for example. The pilot device facilitates the management of fluid supply from the fluid supply system in the process control system in order to maximize the fluid supplied by fluid supply sources in the fluid supply system.

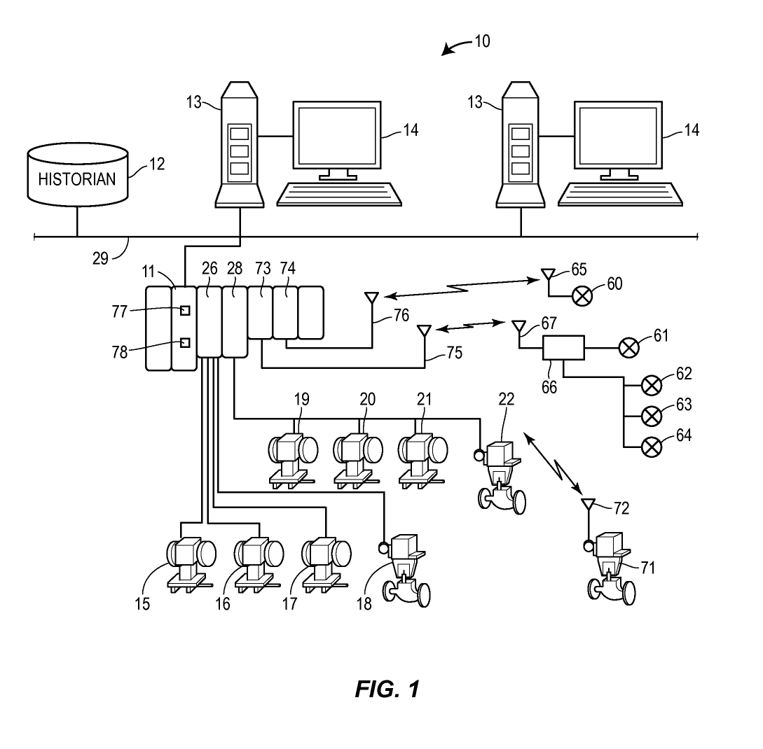

Referring now to FIG. 1, a process control system 10 constructed in accordance with one version of the present disclosure is depicted incorporating one or more field devices 15, 16, 17, 18, 19, 20, 21, 22, and 71 in communication with a process controller 11, which in turn, is in communication with a data historian 12 and one or more user workstations 13, each having a display screen 14. So configured, the controller 11 delivers signals to and receives signals from the field devices 15, 16, 17, 18, 19, 20, 21, 22, and 71 and the workstations 13 to control the process control system.

In additional detail, the process controller 11 of the process control system 10 of the version depicted in FIG. 1 is connected via hardwired communication connections to field devices 15, 16, 17, 18, 19, 20, 21, and 22 via input/output (I/O) cards 26 and 28. The data historian 12 may be any desired type of data collection unit having any desired type of memory and any desired or known software, hardware or firmware for storing data. Moreover, while the data historian 12 is illustrated as a separate device in FIG. 1, it may instead or in addition be part of one of the workstations 13 or another computer device, such as a server. The controller 11, which may be, by way of example, a DeltaV™ controller sold by Emerson Process Management, is communicatively connected to the workstations 13 and to the data historian 12 via a communication network 29 which may be, for example, an Ethernet connection.

As mentioned, the controller 11 is illustrated as being communicatively connected to the field devices 15, 16, 17, 18, 19, 20, 21, and 22 using a hardwired communication scheme which may include the use of any desired hardware, software and/or firmware to implement hardwired communications, including, for example, standard 4-20 mA communications, and/or any communications using any smart communication protocol such as the FOUNDATION® Fieldbus communication protocol, the HART® communication protocol, etc. The field devices 15, 16, 17, 18, 19, 20, 21, and 22 may be any types of devices, such as sensors, control valve assemblies, transmitters, positioners, etc., while the I/O cards 26 and 28 may be any types of I/O devices conforming to any desired communication or controller protocol. In the embodiment illustrated in FIG. 1, the field devices 15, 16, 17, 18 are standard 4-20 mA devices that communicate over analog lines to the I/O card 26, while the digital field devices 19, 20, 21, 22 can be smart devices, such as HART® communicating devices and Fieldbus field devices, that communicate over a digital bus to the I/O card 28 using Fieldbus protocol communications. Of course, the field devices 15, 16, 17, 18, 19, 20, 21, and 22 may conform to any other desired standard(s) or protocols, including any standards or protocols developed in the future.

In addition, the process control system 10 depicted in FIG. 1 includes a number of wireless field devices 60, 61, 62, 63, 64 and 71 disposed in the plant to be controlled. The field devices 60, 61, 62, 63, 64 are depicted as transmitters (e.g., process variable sensors) while the field device 71 is depicted as a control valve assembly including, for example, a control valve and an actuator. Wireless communications may be established between the controller 11 and the field devices 60, 61, 62, 63, 64 and 71 using any desired wireless communication equipment, including hardware, software, firmware, or any combination thereof now known or later developed. In the version illustrated in FIG. 1, an antenna 65 is coupled to and is dedicated to perform wireless communications for the transmitter 60, while a wireless router or other module 66 having an antenna 67 is coupled to collectively handle wireless communications for the transmitters 61, 62, 63, and 64. Likewise, an antenna 72 is coupled to the control valve assembly 71 to perform wireless communications for the control valve assembly 71. The field devices or associated hardware 60, 61, 62, 63, 64, 66 and 71 may implement protocol stack operations used by an appropriate wireless communication protocol to receive, decode, route, encode and send wireless signals via the antennas 65, 67 and 72 to implement wireless communications between the process controller 11 and the transmitters 60, 61, 62, 63, 64 and the control valve assembly 71.

If desired, the transmitters 60, 61, 62, 63, 64 can constitute the sole link between various process sensors (transmitters) and the process controller 11 and, as such, are relied upon to send accurate signals to the controller 11 to ensure that process performance is not compromised. The transmitters 60, 61, 62, 63, 64, often referred to as process variable transmitters (PVTs), therefore may play a significant role in the control of the overall control process. Additionally, the control valve assembly 71 may provide measurements made by sensors within the control valve assembly 71 or may provide other data generated by or computed by the control valve assembly 71 to the controller 11 as part of its operation. Of course, as is known, the control valve assembly 71 may also receive control signals from the controller 11 to effect physical parameters, e.g., flow, within the overall process.

The process controller 11 is coupled to one or more I/O devices 73 and 74, each connected to a respective antenna 75 and 76, and these I/O devices and antennas 73, 74, 75, 76 operate as transmitters/receivers to perform wireless communications with the wireless field devices 61, 62, 63, 64 and 71 via one or more wireless communication networks. The wireless communications between the field devices (e.g., the transmitters 60, 61, 62, 63, 64 and the control valve assembly 71) may be performed using one or more known wireless communication protocols, such as the WirelessHART® protocol, the Ember protocol, a WiFi protocol, an IEEE wireless standard, etc. Still further, the I/O devices 73 and 74 may implement protocol stack operations used by these communication protocols to receive, decode, route, encode and send wireless signals via the antennas 75 and 76 to implement wireless communications between the controller 11 and the transmitters 60, 61, 62, 63, 64 and the control valve assembly 71.

As illustrated in FIG. 1, the controller 11 conventionally includes a processor 77 that implements or oversees one or more process control routines (or any module, block, or sub-routine thereof) stored in a memory 78. The process control routines stored in the memory 78 may include or be associated with control loops being implemented within the process plant. Generally speaking, and as is generally known, the process controller 11 executes one or more control routines and communicates with the field devices 15, 16, 17, 18, 19, 20, 21, 22, 60, 61, 62, 63, 64, and 71, the user workstations 13 and the data historian 12 to control a process in any desired manner(s). Additionally, any one of the field devices 18, 22, and 71 in FIG. 1, each of which is depicted as a control valve assembly, can include an intelligent control valve actuator constructed in accordance with the principles of the present disclosure for communicating with the process controller 11 in order to facilitate monitoring of the actuator's health and integrity.

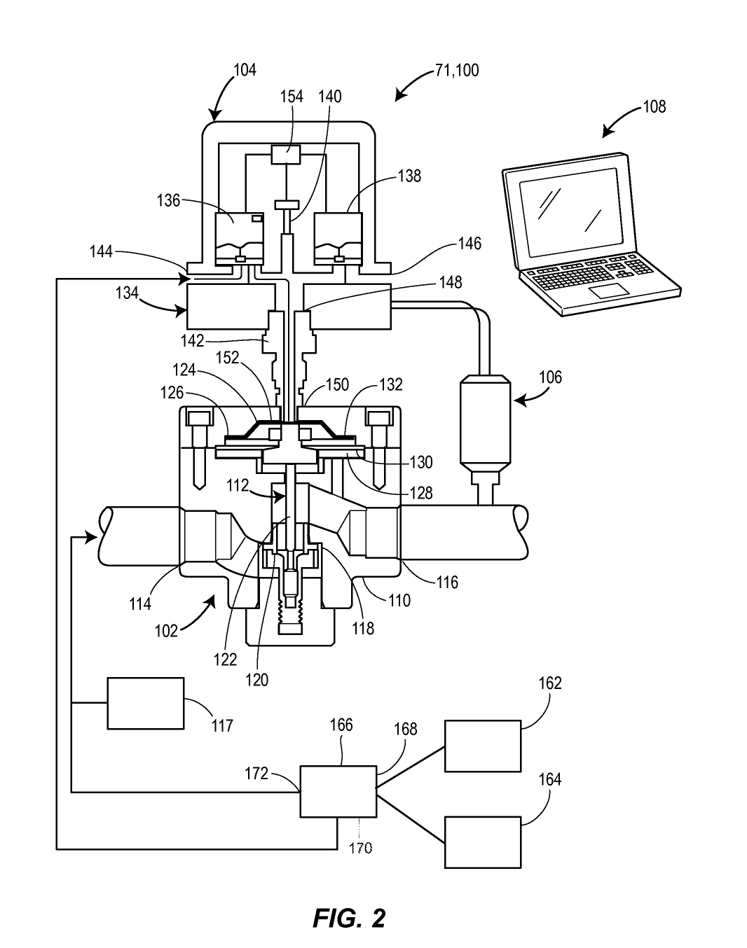

Referring to FIG. 2, for the sake of description, field device 71 from FIG. 1 is shown as an intelligent regulator assembly 100 constructed in accordance with the principles of the present disclosure. As shown in FIG. 2, a fluid supply system 160 is communicatively coupled to the intelligent regulator assembly 100, which is, in turn, communicatively coupled to a plurality of process lines 180.

The fluid supply system 160 is configured to supply compressed fluid to the process lines 180 via various components of the intelligent regulator assembly 100 (e.g., the regulator 102, the pilot device 104). The fluid supply system 160 can supply pressurized gas or pressurized liquid to the components of the assembly 100. The fluid supply system 160 depicted in FIG. 2 includes a first fluid supply source 162, a second fluid supply source 164, and a switching valve 166 communicatively coupled to both the first fluid supply source 162 and the second fluid supply source 164. Each fluid supply source 162, 164 may be or include one tank or cylinder or a plurality of tanks or cylinders (e.g., a bulk supply). The switching valve 166, which is a three-way solenoid driven valve, includes a first inlet 168, a second inlet 170, and an outlet 172. The first fluid supply source 162 is communicatively coupled to the switching valve 166 via the first inlet 168, while the second fluid supply source 164 is communicatively coupled to the switching valve 166 via the second inlet 170. The intelligent regulator assembly 100 is communicatively coupled to the switching valve 166 via the outlet 172, as will be described in greater detail below.

The valve 166 is generally configured to control or regulate which of the fluid supply sources 162, 164 is supplying fluid to the process lines 180. The valve 166 is thus operable (e.g., movable) between a first position and a second position. When the valve 166 is in the first position, the first inlet 168 is open and the second inlet 170 is closed, such that the first fluid supply source 162 is supplying fluid to the process lines 180. When the valve 166 is in the second position, the first inlet 168 is closed and the second inlet 170 is open, such that the second fluid supply source 164 is supplying fluid to the process lines 180. At least initially, the valve 166 is in the first position, such that the first fluid supply source 162 is supplying fluid to the process lines 180.

The process lines 180, via the components of the assembly 100, draw upon the fluid supplied by the first fluid supply source 162. As the pressurized fluid is used, the supply pressure of the first fluid supply source 162 is reduced. The rate of pressure reduction depends upon the size of the fluid supply source 162 and that rate at which the process lines 180 are consuming pressurized fluid. When the first fluid supply source 162 is no longer capable of providing sufficient pressurized fluid (i.e., it needs to be recharged or swapped out), the valve 166 can be switched to the second position. In other words, the valve 166 can close the first inlet 168 and open the second inlet 170, such that the second fluid supply source 164 now supplies fluid to the process lines 180 via the components of the assembly 100. The first fluid supply source 162 can then be recharged or swapped out.

In other examples, the fluid supply system 160 can include any number of fluid supply sources. For example, the fluid supply system 160 can include a single fluid supply source (e.g., a single tank or cylinder) or three or more fluid supply sources, such as, for example, three packs of cylinders. Likewise, the fluid supply system 160 can include a different switching valve 166 and/or the switching valve 166 and the fluid supply sources can be configured differently. For example, the switching valve 166 need not be a solenoid driven valve and/or can have a different number of inlets and/or outlets (e.g., if the fluid supply system 160 includes three or more fluid supply sources).

Still referring to FIG. 2, the intelligent regulator assembly 100 includes a regulator 102, a pilot device 104, and a feedback pressure sensor 106. Additionally, FIG. 2 depicts an optional personal computing device 108 communicatively coupled to the pilot device 104 to enable user interaction with the pilot device 104, as will be described.

The regulator 102 includes a valve body 110 and a control assembly 112. The valve body 110 defines an inlet 114, an outlet 116, and a gallery 118 defining a seating surface 120. The inlet 114 is communicatively coupled to the valve 166 of the fluid supply system 160 via the outlet 172. In other words, the inlet 114 and the outlet 172 provide fluid communication between the regulator 102 and the fluid supply system 160. A fluid supply source pressure sensor 117, which may be, for example, a pressure transducer, is communicatively coupled to this fluid communication and is configured to sense or detect a pressure at the inlet 114 and/or at the outlet 172, depending on the specific location of the sensor 117. The outlet 116 is communicatively coupled to and configured to deliver fluid at a regulated pressure to the process lines 180. A fluid supply source sensor 117 is also communicatively coupled The control assembly 112 is carried within the valve body 110 and includes a control element 122 operably connected to a diaphragm assembly 124. The control element 122 is movable between a closed position in sealing engagement with the seating surface 120 and an open position spaced away from the seating surface 120 in response to pressure changes across the diaphragm assembly 124. As depicted, the diaphragm assembly 124 includes a diaphragm 126 disposed within a diaphragm cavity 128 of the valve body 110 of the regulator 102. The diaphragm assembly 124 also includes a diaphragm pressure sensor 127, which may be, for example, a pressure transducer, configured to sense or detect a pressure near, at, or on the diaphragm 126 (e.g., on the dome 152). A bottom surface 130 of the diaphragm 126 is in fluid communication with the outlet 116 of the valve body 110 and a top surface 132 of the diaphragm 126 is in fluid communication with the pilot device 104 via a pilot opening 150 in the valve body 110.

The pilot device 104 includes a valve body 134, an inlet valve 136, an exhaust valve 138, a pressure sensor 140, and an outlet adaptor 142. The valve body 134 defines an inlet port 144, an exhaust port 146, and an outlet port 148. The inlet port 144 is communicatively coupled to and configured to receive a supply of fluid from the fluid supply system 160 for loading the dome 152 of the regulator 102, as will be described. As depicted, the inlet valve 136 is disposed adjacent to the inlet port 144, the exhaust valve 138 is disposed adjacent to the exhaust port 146, and the outlet adaptor 142 extends from the outlet port 148 and to the pilot opening 150 in the valve body 110. Thus, the outlet adaptor provides 142 fluid communication between the pilot device 104 and the regulator 102. The pressure sensor 140 is disposed in the valve body 134 of the pilot device 104 at a location between the inlet and outlet valves 136, 138. As such, the pressure sensor 140 is operable to sense the pressure between the inlet and outlet valves 136, 138, as well as in the outlet port 148, the outlet adaptor 142, and the diaphragm cavity 128 adjacent to the top surface 132 of the diaphragm 126. This portion of the diaphragm cavity 128 can be referred to as the dome 152 of the regulator 102. In one version of the pilot device 104 the inlet and exhaust valves 136, 138 can be solenoid valves such as Pulse Width Modulation (PWM) solenoid valves and the pressure sensor 140 can be a pressure transducer. Moreover, the inlet and exhaust valves 136, 138 and the pressure sensor 140 can be communicatively coupled to an on-board controller 154, which can store logic and/or direct some or all of the functionality of the pilot device 104, as will be described below.

Still referring to FIG. 2, the feedback pressure sensor 106 of the assembly 100 includes a pressure transducer arranged to detect the pressure at the outlet 116 of the regulator 102 and transmit signals to the pilot device 104 and, more particularly, to the on-board controller 154 of the pilot device 104. Based on the signals received by the on-board controller 154 from the feedback pressure sensor 106, the pilot device 104 opens and/or closes the inlet and exhaust valves 136, 138 to control the pressure in the dome 152 of the regulator 102, which in turn, controls the position of the control element 122 and ultimately the pressure at the outlet 116 of the regulator 102.

Specifically, during normal operation, the pressure at the outlet 116 of the regulator 102 is controlled and maintained as desired by adjusting the pressure in the dome 152 of the regulator 102. This is achieved via operation of the pilot device 104 and feedback pressure sensor 106. For example, in one version, the feedback pressure sensor 106 detects the pressure at the outlet 116 every 25 milliseconds and transmits a signal to the on-board controller 154 of the pilot device 104. The on-board controller 154 compares this signal, which is indicative of the pressure at the outlet 116, to a desired set-point pressure and determines if the outlet pressure is less than, equal to, or greater than the set-point pressure. Based on this determination, the pilot device 104 manipulates either or both of the inlet and exhaust valves 136, 138 to adjust the pressure in the dome 152. That is, if the sensed outlet pressure is lower than the desired set-point pressure, the on-board controller 154 activates the inlet valve 136 (e.g., instructs the inlet valve 136 to open and the exhaust valve 138 to close). In this configuration, gas enters the inlet port 144 of the pilot device 104 and increases the pressure in the dome 152, which causes the diaphragm assembly 124 to urge the control element 122 downward relative to the orientation of FIG. 2, which opens the regulator 102 and increases flow and ultimately pressure at the outlet 116. In contrast, if the pressure sensed at the outlet 116 by the feedback pressure sensor 106 is determined to be higher than the desired set-point pressure, the on-board controller 154 activates the exhaust valve 138 (e.g., instructs the exhaust valve 138 to open and the inlet valve 136 to close). In this configuration, gas in the dome 152 exhausts out through the exhaust port 146 of the pilot device 104 to decrease the pressure on the top surface 132 of the diaphragm 126. This allows the outlet pressure to urge the diaphragm assembly 124 and control element 122 upward relative to the orientation of FIG. 2, which closes the regulator 102 and decreases flow and ultimately pressure at the outlet 116.

Based on the foregoing description, it should be appreciated that the pilot device 104 and the feedback pressure sensor 106 operate in combination with each other to intermittently, yet frequently, monitor the pressure at the outlet 116 of the regulator 102 and adjust the pressure in the dome 152 until the pressure at the outlet 116 is equal to the set-point pressure.

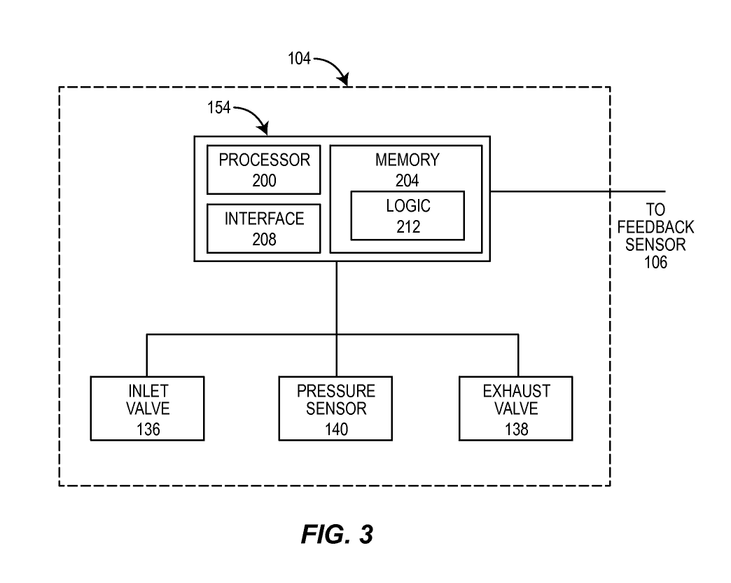

With reference to FIG. 3, the on-board controller 154 may include a processor 200, a memory 204, a communications interface 208, and computing logic 212. The processor 200 may be a general processor, a digital signal processor, ASIC, field programmable gate array, graphics processing unit, analog circuit, digital circuit, or any other known or later developed processor. The processor 200 operates pursuant to instructions in the memory 204. The memory 204 may be a volatile memory or a non-volatile memory. The memory 204 may include one or more of a read-only memory (ROM), random-access memory (RAM), a flash memory, an electronic erasable program read-only memory (EEPROM), or other type of memory. The memory 204 may include an optical, magnetic (hard drive), or any other form of data storage device.

The communications interface 208, which may be, for example, a universal serial bus (USB) port, an Ethernet port, or some other port or interface, is provided to enable or facilitate electronic communication between the pilot device 104 and the computing device 108. This electronic communication may occur via any known method, including, by way of example, USB, RS-232, RS-485, WiFi, Bluetooth, or any other suitable communication connection.

The logic 212 includes one or more routines and/or one or more sub-routines, embodied as computer-readable instructions stored on the memory 204. The pilot device 104, particularly the processor 200, may execute the logic 212 to cause the processor 200 to perform actions related to the configuration, management, maintenance, diagnosis, and/or operation of the regulator 102, the pilot device 104, the fluid supply system 160, and/or the process lines 180. The logic 212 may, when executed, cause the processor 200 to receive and/or obtain signals or requests from the personal computing device 108, receive and/or obtain signals or data from the fluid supply source pressure sensor 117 (which the controller 154 is communicatively coupled to), the diaphragm sensor 127 (which the controller 154 is communicatively coupled to), and/or the feedback sensor 106, determine the contents of any received and/or obtained signals or requests, monitor the pressure detected by the pressure sensor 140, open and/or close the inlet and/or exhaust valves 136, 138, suspend control of the opened and/or closed inlet and/or exhaust valves 136, 138, calculate a minimum source pressure required to permit all of the process lines 180 to run at the same time, change or switch the valve 166 to a different position (e.g., move the valve 166 from the first position to the second position), and, in turn, change the fluid supply source, alert or notify an operator that the fluid supply source 162 or 164 needs to be recharged, record information or data about or pertaining to the fluid supply system 160, predict when one or more of the fluid supply sources 162, 164 will need to be recharged, perform other desired functionality, or combinations thereof.

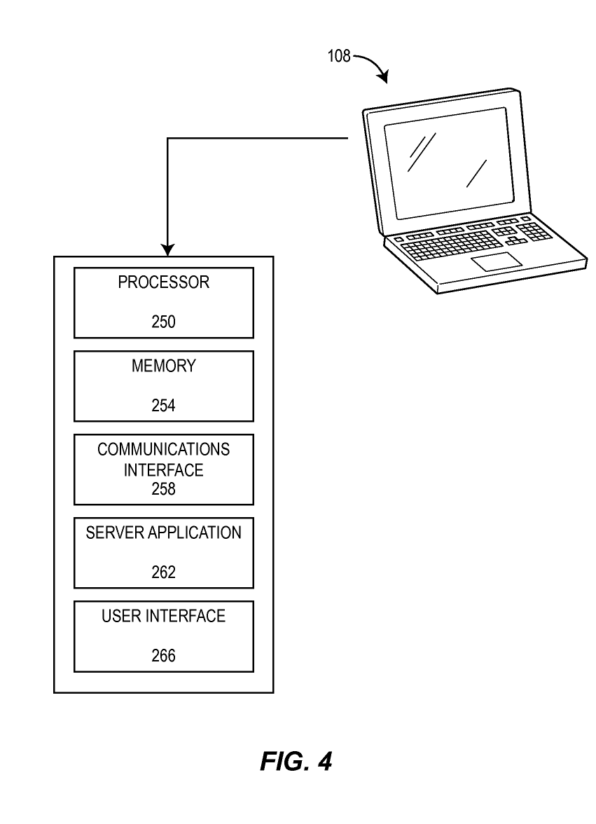

Turning to FIG. 4, further details of the personal computing device 108 will now be described. The personal computing device 108 may be a desktop computer, a notebook computer, a user workstation, a tablet, a hand held computing device (e.g., a smart phone), or other personal computing device. In one embodiment, the personal computing device 108 is the same as the user workstation 13 described in connection with FIG. 1.

As shown in FIG. 4, the personal computing device 108 includes a processor 250, a memory 254, a communications interface 258, and an application 262. The processor 250 may be a general processor, a digital signal processor, ASIC, field programmable gate array, graphics processing unit, analog circuit, digital circuit, or any other known or later developed processor. The processor 250 operates pursuant to instructions in the memory 254. The memory 254 may be a volatile memory or a non-volatile memory. The memory 254 may include one or more of a read-only memory (ROM), random-access memory (RAM), a flash memory, an electronic erasable program read-only memory (EEPROM), or other type of memory. The memory 254 may include an optical, magnetic (hard drive), or any other form of data storage device.

The communications interface 258, which may be, for example, a universal serial bus (USB) port, an Ethernet port, or some other port or interface, is provided to enable or facilitate electronic communication between the personal computing device 108 and the pilot device 104. This electronic communication may occur via any known method, including, by way of example, USB, RS-232, RS-485, WiFi, Bluetooth, or any other suitable communication connection.

The application 262 includes computing logic, such as one or more routines and/or one or more sub-routines, embodied as computer-readable instructions stored on the memory 254 or another memory. The personal computing device 108, particularly the processor 250, may execute the logic to cause the processor 250 to perform actions related to the configuration, management, maintenance, diagnosis, and/or operation (e.g., control or adjustment) of the components of the assembly 100 (e.g., the pilot device 104). The application 262 may facilitate automatic interaction and/or manual interaction with the pilot device 104. For example, the application 262 may facilitate performance of an automated tuning procedure on the pilot device 104. The application 262 may facilitate manual interaction for a user of the personal computing device 108 with the pilot device 104. To this end, the application may include or provide the user with a user interface 266 that facilitates user interaction with (e.g., control of) the pilot device 104.

With or via the user interface 266, the user may calculate or determine a minimum source pressure required to permit all of the process lines 280 to run at the same time (i.e., calculate the lowest source pressure according to the worst case scenario). The user may also utilize the user interface 266 to select or request activation of a suspend control mode in which control of the other components of the assembly 100 (e.g., the regulator 102) by the pilot device 104 is suspended, as will be described in greater detail below. The user may also utilize the user interface 266 to manually tune the pilot device 104, program a set point of the pilot device 104, adjust proportional, derivative, and/or integral values and/or integral limits and/or dead band parameters, set control modes, perform calibration, set control limits, set diaphragm protection values, run diagnostic procedures (e.g., a solenoid leak test), and the like.

As noted above, the fluid supply system 160 is configured to supply pressurized fluid to the process lines 180 via the components of the assembly 100. In order to ensure that each of the process lines 180 is supplied with a sufficient amount of fluid at a required pressure, a certain amount of supply pressure is required. Typically, as briefly described above, process control system operators employ a weighing system, implemented with scales, to determine when the fluid supply source 162 (which, for purposes of this disclosure, is initially active) can no longer provide the requisite amount of fluid at the required pressure (i.e., the fluid supply source 162 needs to be replaced). As part of this weighing system, process control system operators determine a lowest possible weight of the fluid supply source 162 that would guarantee no interruption in the supply of pressurized fluid to the process lines 180. The fluid supply source 162 is then continuously weighed, and when the weight of the fluid supply source 162 approaches this lowest possible weight, it is a signal to the process operators that it is time to replace the fluid supply source change and recharge the fluid supply source 162. Because, however, the predetermined weight is calculated based on all of the process lines 180 running at the same time even though, in reality, this very rarely occurs, the result is that fluid supply sources are often changed and recharged more frequently than is necessary.

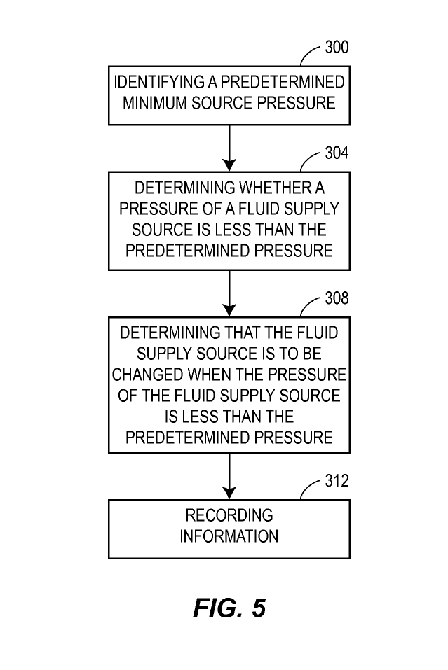

The present embodiments aim to address this problem by managing the supply of pressurized fluid from the fluid supply system 160 to ensure that a maximum amount of fluid is used from the fluid supply system 160 while at the same time the process lines 180 are sufficiently supplied with pressurized fluid. FIG. 5 depicts an exemplary method or process of managing fluid supply in a process control system, such as a process control system that includes the intelligent regulator assembly 100, the fluid supply system 160, and the process lines 180.

The on-board controller 154 of the pilot device 104 first identifies or determines a predetermined minimum source pressure (block 300). The predetermined minimum source pressure is the minimum pressure required at the fluid supply source such that each of the process lines 180 can operate simultaneously. At least initially, then, the predetermined minimum source pressure is the minimum pressure required at the first fluid supply source 162 to permit a simultaneous operation of each of the process lines 180. The predetermined minimum source pressure may be determined by an operator of the process control system (e.g., via the user interface 266) and received by the on-board controller 154 from the operator of the process control system (e.g., via the personal computing device 108). Alternatively, the predetermined minimum source pressure may be automatically determined by the on-board controller. This may be done by, for example, based on the past, current, and/or forecasted fluid demands of the process lines 180.

The on-board controller 154 then determines whether a pressure of the fluid supply source 162 is less than the predetermined minimum source pressure (block 304). The on-board controller 154 may make this determination based on the pressure at the outlet 116 of the regulator 102, the pressure at the inlet 114 of the regulator 102 and/or the outlet 172 of the valve 166, the pressure at or adjacent the diaphragm 126, or combinations thereof. As such, the on-board controller 154 is configured to receive and analyze feedback control signals from the feedback pressure sensor 106, as described above, data from the supply pressure sensor 117, and/or data from the diaphragm pressure sensor 127.

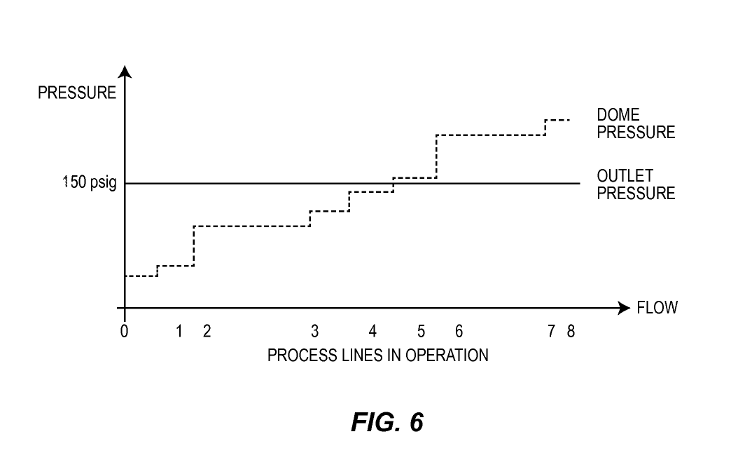

In some embodiments, the determination of whether the pressure of the fluid supply source 162 is less than the predetermined minimum source pressure is based, at least partially, on the pressure at the outlet 116 of the regulator 102. In these embodiments, the on-board controller 154 receives a first feedback control signal from the feedback pressure sensor 154, and the on-board controller 154 compares the first feedback control signal to a set-point control value to determine if the pressure at the outlet 116 of the regulator 102 is greater than a set-point pressure. When the first feedback control signal is determined to be less than the set-point control value (i.e., the outlet pressure is below the set-point pressure), the on-board controller 154 opens the inlet valve 136 of the pilot device 104, such that gas enters the inlet port 144 of the pilot device, the pressure in the dome 152 increases, and, ultimately, the pressure at the outlet 116 increases. FIG. 6 is an illustrative example of how the dome pressure required in the regulator 102 varies according to the flow requirements of the process lines 180.

Sometime after the on-board controller 154 opens the inlet valve 136 of the pilot device 104, the on-board controller 154 receives a second feedback control signal from the feedback pressure sensor 106. The on-board controller 154 compares the second feedback control signal to the first feedback control signal to determine whether the pressure at the outlet 116 of the regulator 102 has increased. When the pressure at the outlet 116 of the regulator 102 has not increased (as it normally should), the on-board controller 154 determines that the pressure of the fluid supply source 162 is less than the predetermined minimum source pressure (i.e., the on-board controller 154 concludes that the predetermined minimum source pressure has been reached and the fluid supply source 162 needs to be replaced and recharged). When, however, the pressure at the outlet 116 has increased, the on-board controller 154 determines that the pressure of the fluid supply has not yet reached the predetermined minimum source pressure (i.e., the pressure of the fluid supply is greater than the predetermined required pressure) and the normal operation of the assembly 100 continues as described above.

Alternatively or additionally, the on-board controller 154 can take into account the detected pressure at the inlet 114 of the regulator 102 and/or the outlet 172 of the valve 166 and/or the detected pressure at or adjacent the diaphragm 126 when determining whether a pressure of the fluid supply source 162 is less than the predetermined minimum source pressure. For example, the on-board controller 154 may determine that the pressure of the fluid supply source 162 is less than the predetermined minimum source pressure when one or more threshold pressures (e.g., threshold pressures corresponding to the pressure at the inlet 114, the outlet 172, and/or the diaphragm 126) are reached. As another example, the on-board controller 154 may analyze the relationship (e.g., the ratio(s), the correlation(s)) between the various pressure values and determine that the pressure of the fluid supply source 162 is less than the predetermined minimum source pressure when certain relationships exist (e.g., when certain ratios are found).

When the on-board controller 154 determines that the pressure of the fluid supply source 162 is less than the predetermined minimum source pressure, the on-board controller 154 determines that the fluid supply source 162 can no longer provide a sufficient supply of pressurized fluid to the process lines 180 and needs to be changed or switched out (block 308). In some embodiments, the on-board controller 154 may, upon making this determination, change the fluid supply source supplying pressurized fluid to the process lines 180 from the first fluid supply source 162 to the second fluid supply source 164. This can be done by, for example, switching or moving the valve 166 from the first position, in which the first inlet 168 is open and the second inlet 170 is closed, to the second position, in which the first inlet 168 is closed and the second inlet 170 is opened. In effect, by switching the valve 166 from the first position to the second position, the on-board controller 154 switches the fluid supply source from the first fluid supply source 162 to the second fluid supply source 164. Alternatively or additionally, the on-board controller 154 may notify or alert the operator of the process control system (e.g., via the user interface 266, via email, via a notification alarm, or via some other way) that the fluid supply source is to be changed. In embodiments in which the fluid supply system 160 does not include the valve 166 and, thus, the fluid supply source cannot be changed by switching the valve 166, another device or the operator can instead change or switch the fluid supply source. Once switched out, the old fluid supply source 162 can then be recharged.

The on-board controller 154 can, in some embodiments, record information or data about the process control system when the on-board controller 154 is determining whether the pressure of the fluid supply source 162 is less than the predetermined minimum source pressure and/or when it is determined that the fluid supply source is to be changed (block 312). The on-board controller 154 can, for example, record the pressure at the inlet 114 of the regulator 102, the pressure at the outlet 116 of the regulator 102, the pressure at the outlet 172 of the valve 166, information about the fluid supply source 162 (e.g., size of the source 162, make and/or model of the source 162, how long the source 162 was supplying pressurized fluid to the process lines 180), information about the fluid supply source changeover (e.g., date and/or time of the changeover), other information or data, or combinations thereof. As the on-board controller 154 records more and more information, the on-board controller 154 can intelligently identify patterns (e.g., depletion rates of fluid supply sources and/or the process lines 180) and predict when fluid supply sources will need to be changed. For example, the on-board controller 154 may predict that the fluid supply source 162 will need to be changed in 10 hours. By doing so, the on-board controller 154 may allow the operator of the process control system to better plan changeovers. For example, if the operator of the process control system plans to conduct a long test, the on-board controller 154 may, by predicting when the fluid supply source will need to be changed, help the operator determine whether the fluid supply source should be changed before or after the test.

Although not explicitly described herein, the above-described method, and/or any steps therein, may be performed any number of times. For example, the above-described method may be utilized in connection with the first fluid supply source 162 and the second fluid supply source 164 and/or in connection with other fluid supply sources.

Based on the foregoing description, it should be appreciated that the devices and methods described herein facilitate the management of fluid supply in a process control system. By managing the fluid supply as described herein, the disclosed devices and methods obviate the need for conventional weighing systems, which can be expensive and can require significant storage space, and maximize the amount of fluid used from the fluid supply system, thus ensuring that fluid sources are only changed when necessary and, in turn, reducing the frequency at which fluid sources need to be changed. By reducing the frequency at which fluid sources need to be changed, process control operators can save money and reduce the amount of downtime for one or more process lines in their process control systems.

1. A process control system comprising:
a fluid supply source;
a regulator including an inlet operably coupled to the fluid supply source and an outlet configured to deliver fluid at a regulated pressure;
a pilot device coupled to the regulator, the pilot device including an inlet port having an inlet valve and being operably coupled to and configured to receive a supply of loading fluid from the fluid supply source, an exhaust port having an exhaust valve, an outlet port configured to output a controlled pressure to the regulator, and an on-board controller communicatively coupled to the inlet valve and the exhaust valve and operable to control the inlet valve and the exhaust valve, the inlet valve movable between an open position to open the inlet port for delivering the supply of loading fluid to the outlet port and a closed position to close the inlet port, and the exhaust valve movable between an open position to open the exhaust port and exhaust fluid away from the regulator and a closed position to close the exhaust port;
a feedback pressure sensor connected between the outlet of the regulator and the on-board controller of the pilot device, the feedback pressure sensor configured to periodically sense a pressure at the outlet of the regulator and send a feedback control signal to the on-board controller, the feedback control signal indicative of the magnitude of the sensed pressure;
a plurality of process lines connected to the outlet of the regulator and configured to operate using the fluid at the regulated pressure;
wherein the on-board controller includes a memory, a processor, and logic stored on the memory, the logic stored on the memory of the on-board controller executable by the processor to:
identify a predetermined minimum source pressure, the predetermined minimum source pressure being the minimum pressure required at the fluid supply source to permit a simultaneous operation of all of the process lines;
determine whether a pressure of the fluid supply source is less than the predetermined required pressure; and
determine that the fluid supply source is to be changed when the pressure of the fluid supply source is less than the predetermined required pressure.

2. The process control system of claim 1, wherein the logic stored on the memory of the on-board controller is executable by the processor to determine whether the pressure of the fluid supply source is less than the predetermined minimum source pressure based on the pressure at the outlet of the regulator.

3. The process control system of claim 1, wherein the logic stored on the memory of the on-board controller is executable by the processor to:
receive a first feedback control signal from the feedback pressure sensor;
compare the first feedback control signal to a set-point control value to determine if the pressure at the outlet of the regulator is greater than a set-point pressure;
open the inlet valve of the pilot device when the first feedback control signal is determined to be less than the set-point control value such that loading fluid enters the inlet port of the pilot device;
receive a second feedback control signal from the feedback pressure sensor; and
compare the second feedback control signal to the first feedback control signal to determine whether the pressure at the outlet of the regulator has increased;
wherein the logic stored on the memory of the on-board controller is executable by the processor to determine that the pressure of the fluid supply is less than the predetermined minimum source pressure when the pressure at the outlet of the regulator has not increased.

4. (canceled)

5. (canceled)

6. The process control system of claim 1, wherein the logic stored on the memory of the on-board controller is executable by the processor to change the fluid supply source when it is determined that the fluid supply source is to be changed.

7. The process control system of claim 1, wherein the logic stored on the memory of the on-board controller is executable by the processor to record information about the process control system when the on-board controller is determining whether the pressure of the fluid supply source is less than the predetermined minimum source pressure, the information about the process control system comprising the pressure of the fluid supply source, the pressure at the outlet of the regulator, information about the fluid supply source, a time for which the fluid supply source has been operably coupled to the pilot device and the regulator, or combinations thereof.

8. (canceled)

9. The process control system of claim 7, wherein the logic stored on the memory of the on-board controller is executable by the processor to predict when the fluid supply source will need to be changed based on the recorded information.

10. The process control system of claim 1, wherein the logic stored on the memory of the on-board controller is executable by the processor to notify an operator of the process control system that the fluid supply source is to be changed.

11. The process control system of claim 1, wherein the logic stored on the memory of the on-board controller is executable by the processor to record information about the process control system when it is determined that the fluid supply source is to be changed, the information about the process control system comprising the pressure of the fluid supply source, the pressure at the outlet of the regulator, information about the fluid supply source, a time for which the fluid supply source has been operably coupled to the pilot device and the regulator, or combinations thereof.

12. (canceled)

13. The process control system of claim 1, the regulator further including a control element and a diaphragm assembly, the diaphragm assembly having a diaphragm operably coupled to the control element and a diaphragm sensor configured to sense a pressure at the diaphragm, the diaphragm configured to move the control element in response to pressure changes across the diaphragm to control the flow of fluid from the inlet to the outlet,
the pilot device coupled to the regulator for loading a top surface of the diaphragm, the outlet port of the pilot device being in fluid communication with the top surface of the diaphragm of the regulator, the pilot device further including a loading pressure sensor disposed between the inlet valve and the outlet valve and in fluid communication with the outlet port and the top surface of the diaphragm, and the on-board controller communicatively coupled to the fluid supply source, the inlet valve, the exhaust valve, and the loading pressure sensor, the inlet valve movable between the open position to open the inlet port for delivering the supply of loading fluid to the outlet port and the top surface of the diaphragm and the closed position to close the inlet port, and the exhaust valve movable between the open position to open the exhaust port and exhaust fluid away from the top surface of the diaphragm and the closed position to close the exhaust port.

14-23. (canceled)

24. A process control system comprising:
a fluid supply system comprising a first fluid supply source and a second fluid supply source;
a valve having a first inlet operably coupled to the first fluid supply source, a second inlet operably coupled to the second fluid supply source, and an outlet, the valve being in a first position in which the first inlet is open and the second inlet is closed, and movable to a second position in which the second inlet is open and the first inlet is closed;
a regulator including an inlet, an outlet, a control element, and a diaphragm assembly, the inlet operatively coupled to the fluid supply system via the outlet of the valve, the outlet configured to deliver fluid at a regulated pressure, and the diaphragm assembly having a diaphragm operably coupled to the control element and configured to move the control element in response to pressure changes across the diaphragm to control the flow of fluid from the inlet to the outlet;
a pilot device coupled to the regulator for loading a top surface of the diaphragm, the pilot device including an inlet port having an inlet valve and being operably coupled to and configured to receive a supply of loading fluid from the fluid supply system, an exhaust port having an exhaust valve, an outlet port in fluid communication with the top surface of the diaphragm of the regulator, a loading pressure sensor disposed between the inlet valve and the outlet valve and in fluid communication with the outlet port and the top surface of the diaphragm, and an on-board controller communicatively coupled to the fluid supply system, the inlet valve, the exhaust valve, and the loading pressure sensor, the inlet valve movable between an open position to open the inlet port for delivering the supply of loading fluid to the outlet port and the top surface of the diaphragm and a closed position to close the inlet port, and the exhaust valve movable between an open position to open the exhaust port and exhaust fluid away from the top surface of the diaphragm and a closed position to close the exhaust port;
a feedback pressure sensor connected between the outlet of the regulator and the on-board controller of the pilot device, the feedback pressure sensor configured to periodically sense a pressure at the outlet of the regulator and send a feedback control signal to the on-board controller, the feedback control signal indicative of the magnitude of the sensed pressure;
a plurality of process lines connected to the outlet of the regulator and configured to operate using the fluid at the regulated pressure;
wherein the on-board controller includes a memory, a processor, and logic stored on the memory, the logic stored on the memory of the on-board controller executable by the processor to:
identify a predetermined minimum source pressure, the predetermined minimum source pressure being the minimum pressure required at a fluid supply source to permit a simultaneous operation of all of the process lines;
determine whether a pressure of the first fluid supply source is less than the predetermined minimum source pressure; and
determine that the first fluid supply source needs to be changed and move the valve the second position when the pressure of the first fluid supply source is less than the predetermined minimum source pressure.

25. The process control system of claim 24, wherein the logic stored on the memory of the on-board controller is executable by the processor to determine whether the pressure of the first fluid supply source is less than the predetermined minimum source pressure based on the pressure at the outlet of the regulator.

26. The process control system of claim 24, wherein the logic stored on the memory of the on-board controller is executable by the processor to:
receive a first feedback control signal from the feedback pressure sensor;
compare the first feedback control signal to a set-point control value to determine if the pressure at the outlet of the regulator is greater than a set-point pressure;
open the inlet valve of the pilot device when the first feedback control signal is determined to be less than the set-point control value such that loading fluid enters the inlet port of the pilot device;
receive a second feedback control signal from the feedback pressure sensor; and
compare the second feedback control signal to the first feedback control signal to determine whether the pressure at the outlet of the regulator has increased;
wherein the logic stored on the memory of the on-board controller is executable by the processor to determine that the pressure of the first fluid supply source is less than the predetermined minimum source pressure when the pressure at the outlet of the regulator has not increased.

27. (canceled)

28. (canceled)

29. The process control system of claim 24, wherein the diaphragm assembly further comprises a diaphragm sensor configured to sense a pressure at the diaphragm, and wherein the logic stored on the memory of the on-board controller is executable by the processor to determine whether a pressure of the first fluid supply source is less than the predetermined minimum source pressure based on the pressure at the diaphragm.

30. The process control system of claim 24, further comprising a fluid supply sensor operably coupled to the valve, and wherein the logic stored on the memory of the on-board controller is executable by the processor to determine whether a pressure of the first fluid supply source is less than the predetermined minimum source pressure using the fluid supply sensor.

31. (canceled)

32. (canceled)

33. The process control system of claim 24, wherein the logic stored on the memory of the on-board controller is executable by the processor to predict when the first fluid supply source will need to be changed based on information recorded about the process control system when the on-board controller is determining whether the pressure of the first fluid supply source is less than the predetermined minimum source pressure.

34. The process control system of claim 24, wherein the logic stored on the memory of the on-board controller is executable by the processor to notify an operator of the process control system that the first fluid supply source is to be changed when the pressure of the first fluid supply source is less than the predetermined minimum source pressure.

35. The process control system of claim 24, wherein the logic stored on the memory of the on-board controller is executable by the processor to record information about the process control system when it is determined that the first fluid supply source is to be changed, the information about the process control system comprising the pressure of the first fluid supply source, the pressure at the diaphragm, the pressure at the outlet of the regulator, information about the first fluid supply source, a time for which the first fluid supply source has been operably coupled to the pilot device and the regulator, or combinations thereof.

36. (canceled)

37. A method of managing fluid supply in a process control system comprising a fluid supply source, a regulator, a pilot device, a feedback sensor, and a plurality of process lines, the method comprising:
identifying, via a controller of the pilot device, a predetermined minimum source pressure, the predetermined minimum source pressure being the minimum pressure required at the fluid supply source to permit a simultaneous operation of all of the process lines;
determining, via the controller, whether a pressure of the fluid supply source is less than the predetermined minimum source pressure; and
determining, via the controller, that the fluid supply source is to be changed when the pressure of the fluid supply source is less than the predetermined minimum source pressure.

38. The method of claim 37, wherein determining whether the pressure of the fluid supply source is less than the predetermined minimum source pressure comprises determining whether the pressure of the fluid supply source is less than the predetermined minimum source pressure based on a pressure at an outlet of the regulator.

39. The method of claim 37, wherein determining whether the pressure of the fluid supply source is less than the predetermined minimum source pressure comprises determining whether the pressure of the fluid supply source is less than the predetermined minimum source pressure based on a pressure at an outlet of the regulator and a pressure at a diaphragm of the regulator.

40. (canceled)

41. (canceled)

42. The method of claim 37, wherein determining whether the pressure of the fluid supply source is less than the predetermined minimum source pressure comprises:
receiving a first feedback control signal from the feedback pressure sensor;
comparing the first feedback control to a set-point control value to determine if the pressure at the outlet of the regulator is greater than a set-point pressure;
opening an inlet valve of the pilot device when the first feedback control signal is determined to be less than the set-point control value such that loading fluid enters an inlet port of the pilot device;
receiving a second feedback control signal from the feedback pressure sensor; and
comparing the second feedback control signal to the first feedback control signal to determine whether the pressure at the outlet of the regulator has increased;
wherein determining when the pressure of the fluid supply source is less than the predetermined minimum source pressure comprises determining that the pressure at the outlet of the regulator has not increased.

43. The method of claim 37, further comprising changing the fluid supply source when it is determined that the fluid supply source is to be changed.

44. The method of claim 37, further comprising notifying an operator of the process control system that the fluid supply source is to be changed.

45. The method of claim 37, further comprising recording information about the process control system when the on-board controller is determining whether the pressure of the fluid supply source is less than the predetermined minimum source pressure, the recording comprising recording the pressure of the fluid supply source, the pressure at the outlet of the regulator, information about the fluid supply source, a time for which the fluid supply source has been operably coupled to the pilot device and the regulator, or combinations thereof.

46. (canceled)

47. The method of claim 45, further comprising predicting when the fluid supply source will need to be recharged based on the recorded information.

48-57. (canceled)
